(19) United States
(12) Patent Application Publication
(10) Pub. No.: US 2005/0176398 A1
(43) Pub. Date: Aug. 11, 2005

(54) Mixer circuit

(76) Inventors: Kenichi Maeda, Tokyo (JP); Kenji Itoh, Tokyo (JP); Hiroyuki Joba, Tokyo (JP); Takayuki Ikushima, Tokyo (JP); Yoshinori Takahashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/515,629

(22) PCT Filed: Aug. 23, 2002
(86) PCT No.: PCT/JP02/08519

(51) Int. Cl. H04B 1/26; G06G 7/16; G06F 7/44

(52) U.S. Cl. 455/326; 327/359

(57) ABSTRACT

A mixer circuit mixes a target signal with a local oscillation signal to perform frequency conversion of the target signal. Since the mixer circuit uses a pseudo-sine wave as the local oscillation signal, it can carry out stable operation regardless of variations in the amplitude of the local oscillation signal.

### TECHNICAL FIELD

The present invention relates to a mixer circuit, and more particularly to an even harmonic mixer used for mobile communication.

### BACKGROUND ART

As for apparatuses for carrying out transmission using a radio frequency signal such as portable phones or televisions, if they amplify or modulate the radio frequency signal (called “RF signal” from now on) received from an antenna without change, they are unstable because they will have oscillation within their circuits. In contrast with this, as for an intermediate frequency signal (called “IF signal” from now on), although it cannot be radiated into the air, it is easily modulated and does not cause oscillation. Thus, a mixer for converting the frequency of a signal to an intermediate frequency or to a radio frequency is used in transmission and reception.

An ordinary mixer utilizes the phenomenon that supplying a radio frequency signal and a local oscillation signal (call “LO signal” from now on), which has a periodic waveform like a sine wave, to a device with nonlinear characteristics such as a transistor or diode generate a signal with various frequencies.

FIG. 8 is a block diagram showing the role of a mixer in a transmitter and receiver such as a superheterodyne transmitter and receiver. In FIG. 8, the reference numeral 13 designates a local oscillation signal generator (called “LO signal generator” from now on), 20 designates a mixer, 21 designates an antenna, 22 designates an amplifier and 23 designates a modulator and demodulator.

In the receiving operation, the antenna 21 receives an RF signal, and the high frequency amplifier 22 amplifies the radio frequency signal and supplies it to the mixer 20. The mixer 20 has a nonlinear characteristic device, to which the input RF signal and the sinusoidal LO signal generated by the local oscillation signal generator 13 are input, and supplies the generated IF signal to the modulation-demodulation circuit 23.

In the transmitting operation, the IF signal of speech or the like passing through the modulation by the modulation-demodulation circuit 23 is supplied to the mixer 20. The mixer 20 mixes the IF signal with the sinusoidal LO signal generated by the LO signal generator 13. The RF signal thus obtained is amplified by the amplifier 22 and is radiated into the air via the antenna 21.

As an example of a mixer, there is an even harmonic mixer that has been employed by a portable phone or the like recently. The even harmonic mixer is suitable for high frequency operation at extremely high frequency and the like because when it is applied to a transmitter, it exhibits low spurious and can halve the LO frequency as compared with an ordinary mixer operating at the fundamental wave, which will be described later.

FIG. 9 is a schematic diagram of a conventional even harmonic mixer circuit disclosed in Proceedings of the 2001 IEICE Electronics Society Conference C-2-6 (P. 30). In FIG. 9, the reference numeral 1a designates a local oscillation signal input terminal for inputting a local oscillation signal (called an “LO signal” from now on); 2a designates a high frequency signal input terminal for inputting a high frequency signal (called an “RF signal” from now on); 3a designates an output signal terminal; 4a designates a wave splitter circuit; 4c designates a bandpass filter in the wave splitter circuit 4a; 4d designates a high-pass filter in the wave splitter circuit 4a; and 4e designates a low-pass filter in the wave splitter circuit 4a. The reference numerals 5a and 5b each designate a mixer diode; the reference numeral 6a designates an antiparallel diode pair; and 7 designates a local oscillation signal generator.

Next, the circuit operation of FIG. 9 will be described. FIG. 9 shows an example serving as a down converter for converting the radio frequency to the intermediate frequency. The RF signal (with a frequency of fin) input to the RF signal input terminal 2a and the LO signal (with a frequency of fp) input to the LO signal input terminal 1a are supplied to the antiparallel diode pair 6a via the wave splitter circuit 4a. Here, the local oscillation signal generator 7 oscillates a sine wave as the LO signal.

The antiparallel diode pair 6a consists of two antiparallel mixer diodes 5a and 5b. As for the mixer diode 5a, during the application of a positive voltage v at every period of the LO signal, current i flows through it. As for the mixer diode 5b, during the application of a negative voltage after a half period of the application of the positive voltage v of the LO signal, the current i flows through it. Accordingly, the mixer diodes 5a and 5b turn on alternately at every half period as illustrated in FIG. 10, thereby passing the current i. Thus, the opposite phase LO current flows through the antiparallel diode pair 6a at every half period. The forward conductance g=di/dv of the diode varies nonlinearly depending on the instantaneous value of the current i, and increases at every half period as illustrated in FIG. 11. Accordingly, the harmonic of the LO current contains only odd order components, and the harmonic of the conductance contains only even order components. Superimposing the RF signal on the LO signal distorts the RF signal because of the nonlinearity of the conductance g, thereby generating a variety of frequency components, above all generating the frequency fin−2fp.

Thus the even harmonic mixer applied to the reception can mix the input RF signal with the double frequency (2fp) wave of the LO signal as illustrated in FIG. 12. As a result, the even harmonic mixer can operate at the half frequency fp as compared with the mixer operating at the fundamental wave, and hence is applied to the transmission and reception of microwaves.

In addition, as illustrated in FIG. 12, the second harmonic (2fp) of the LO wave, a spurious wave near the RF signal, is suppressed within the antiparallel diode pair 6a to a low spurious wave. The reduced amount is determined by the balance between the two mixer diodes 5a and 5b. The smaller the characteristic difference between the two diodes, the greater the even order harmonics of the LO signal and the odd order harmonic of the conductance can be suppressed. Consequently, comparing with an ordinary balanced mixer, the even harmonic mixer can perform much greater suppression. For example, although the ordinary mixer with the fundamental wave operation has the suppression value of about 25 dB, the even harmonic mixer enables the suppression of about 50-60 dB in the microwaves.

As described above, the conventional mixer circuit uses the sine wave as the LO signal. The local oscillation signal generator 13, however, can sometimes generate only the sine wave with a higher or lower amplitude than a specified amplitude because of variations in semiconductor process. In such a case, the mixer, which assumes the operation based on the specified amplitude, has the time ratio (called “mixing duty” from now on), in which the mixing is performed during the period of the LO signal, varied as illustrated in FIGS. 13(a) and 13(b) depending on the deviation from the amplitude. As for the even harmonic mixer of FIG. 9, the mixing on and off characteristics depend on the driving voltage of the diodes.

FIG. 14 is a graph showing the dependence of the conversion gain on the amplitude when the LO signal is sinusoidal. As illustrated in FIG. 14, the conversion gain of the mixer varies greatly if the amplitude of the LO signal fed from the outside varies because of the variations in the device characteristics during manufacturing. This presents a problem in that the mixer cannot perform stable circuit operation.

### DISCLOSURE OF THE INVENTION

The present invention is implemented to solve the foregoing problem. Therefore it is an object of the present invention to provide an even harmonic mixer circuit capable of suppressing the dependence of the conversion gain of the mixer on the amplitude of the LO signal by eliminating the variations in the mixing duty due to the amplitude of the LO signal.

According to an aspect of the present invention, there is provided a mixer circuit including: a signal synthesizing circuit for synthesizing and outputting a pseudo-sine wave from a pulse signal or a sine wave, which is input from outside and has a constant period; and a mixing section for mixing the output signal from the local oscillation signal synthesizing circuit with a target signal input from an outside, and for frequency converting and outputting the mixed signal.

### BRIEF DESCRIPTION OF THE DRAWINGS

FIG. 1 is a diagram showing a circuit configuration of an embodiment 1 of the even harmonic mixer in accordance with the present invention;

FIG. 2(a) is a diagram illustrating a waveform of a first pulse signal input to the embodiment 1 of the even harmonic mixer in accordance with the present invention;

FIG. 2(b) is a diagram illustrating a waveform of a second pulse signal input to the embodiment 1 of the even harmonic mixer in accordance with the present invention;

FIG. 2(c) is a diagram illustrating a waveform of a local oscillation signal synthesized by an adder circuit of the embodiment 1 of the even harmonic mixer in accordance with the present invention;

FIG. 3(a) is a diagram illustrating a case in which the amplitude varies of the local oscillation signal of the even harmonic mixer in accordance with the present invention;

FIG. 3(b) is a diagram illustrating that the mixing duty is kept constant regardless of the variations in the amplitude of the local oscillation signal of the even harmonic mixer in accordance with the present invention;

FIG. 4 is a diagram illustrating the dependence of the conversion gain of the embodiment 1 of the even harmonic mixer in accordance with the present invention on the amplitude of the local oscillation signal;

FIG. 5 is a diagram showing a circuit configuration of an embodiment 2 of the even harmonic mixer in accordance with the present invention;

FIG. 6(a) is a diagram illustrating a waveform of a first pulse signal input to the embodiment 2 of the even harmonic mixer in accordance with the present invention;

FIG. 6(b) is a diagram illustrating a waveform of a second pulse signal input to the embodiment 2 of the even harmonic mixer in accordance with the present invention;

FIG. 6(c) is a diagram illustrating a waveform of a first local oscillation signal synthesized by an adder circuit of the embodiment 2 of the even harmonic mixer in accordance with the present invention;

FIG. 6(d) is a diagram illustrating a waveform of a third pulse signal input to the embodiment 2 of the even harmonic mixer in accordance with the present invention;

FIG. 6(e) is a diagram illustrating a waveform of a fourth pulse signal input to the embodiment 2 of the even harmonic mixer in accordance with the present invention;

FIG. 6(f) is a diagram illustrating a waveform of a second local oscillation signal synthesized by the adder circuit of the embodiment 2 of the even harmonic mixer in accordance with the present invention;

FIG. 7 is a diagram showing a circuit configuration of an embodiment 3 of the even harmonic mixer in accordance with the present invention;

FIG. 8 is a block diagram showing a configuration of a superheterodyne transmitter and receiver;

FIG. 9 is a diagram showing a circuit configuration of a conventional even harmonic mixer;

FIG. 10 is a diagram illustrating variations in the current flowing through an antiparallel diode pair versus an LO period;

FIG. 11 is a diagram illustrating the conductance of the antiparallel diode pair versus the LO period;

FIG. 12 is a diagram illustrating frequency components of signals generated by the even harmonic mixer;

FIG. 13(a) is a diagram illustrating a waveform of a conventional local oscillation signal;

FIG. 13(b) is a diagram illustrating variations in the mixing duty because of the variations in the amplitude of the conventional local oscillation signal; and

FIG. 14 is a diagram illustrating the dependence of the conversion gain of the conventional even harmonic mixer on the amplitude of the local oscillation signal.

### BEST MODE FOR CARRYING OUT THE INVENTION

### Embodiment 1

The embodiment 1 in accordance with the present invention will be described by way of example of a mixer that carries out stable operation independently of the amplitude variations of the local oscillation signal. The stable operation is achieved because the present embodiment 1 employs as the local oscillation signal a periodic signal (called “pseudo-sine wave” from now on) that alternates a rectangular waveform which has at least one voltage level and is convex upward, with a rectangular waveform which has a voltage level lower than that at least one voltage level and is convex downward. The voltage level of the pseudo-sine wave may be either positive or negative.

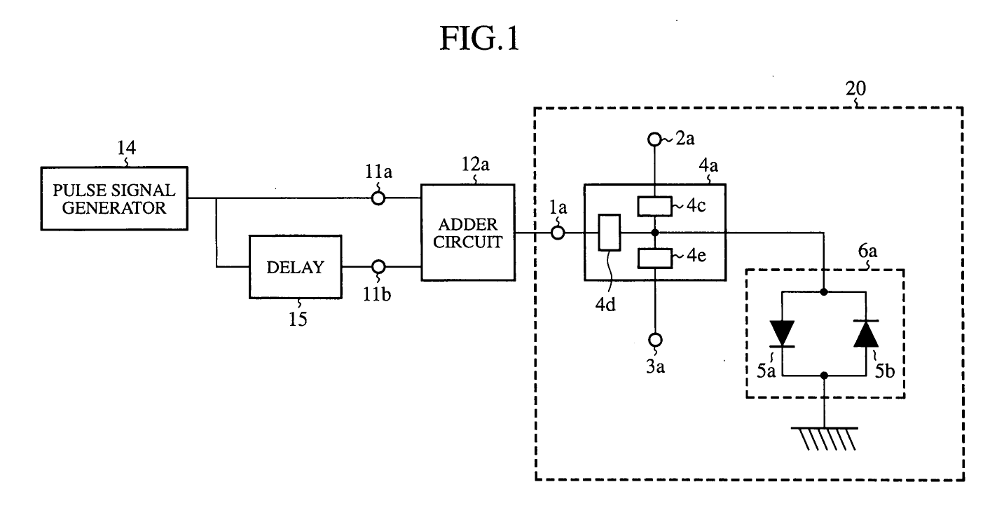

FIG. 1 is a schematic diagram showing an embodiment 1 of the even harmonic mixer in accordance with the present invention. In FIG. 1, the reference numeral 1a designates an LO signal input terminal, 2a designates an RF signal input terminal, 3a designates an IF signal output terminal, 4a designates a wave splitter circuit, 4c designates a bandpass filter, 4d designates a high-pass filter, 4e designates a low-pass filter, 5a and 5b each designate a mixer diode, 6a designates an antiparallel diode pair, 11a and 11b each designate an adder circuit LO signal input terminal, 12a designates an adder circuit, 14 designates a pulse signal generator, 15 designates a delay circuit and 20 designates an even harmonic mixer including the wave splitter circuit 4a and antiparallel diode pair 6a.

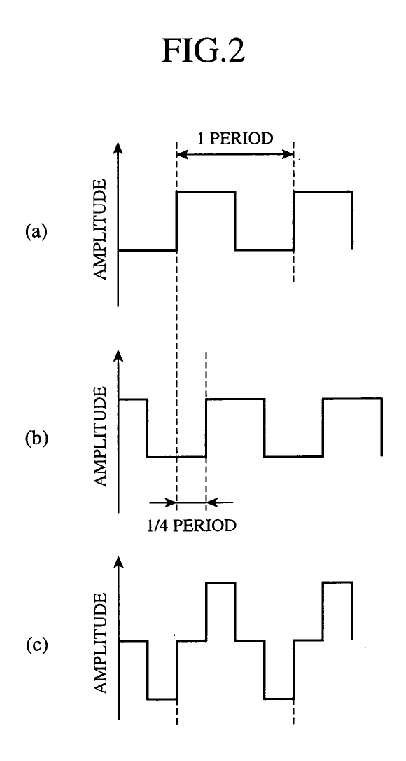

Next, the operation will be described. As illustrated in FIGS. 2(a) and 2(b), the adder circuit LO signal input terminals 11a and 11b are supplied with two pulse signals which are generated by the pulse signal generator 14, and one of which is delayed about ¼ period by the delay circuit 15. The adder circuit 12a adds the two signals to generate a pseudo-sine wave that has three voltage values and has a mixing duty of 50% as illustrated in FIG. 2(c). When the mixer 20 in accordance with the present invention is applied to a portable phone, for example, the pulse signal generator 14 can employ any digital circuit connected to the outside of the mixer 20 without change as long as the digital circuit generates a periodic rectangular wave such as a clock pulse signal.

The antiparallel diode pair 6a includes two antiparallel mixer diodes 5a and 5b. The even harmonic mixer as shown in FIG. 1 operates as a down converter that outputs the IF signal from the IF signal output terminal 3a via the low-pass filter 4e of the wave splitter circuit 4a. The operation is achieved by supplying the RF signal and LO signal fed via the RF signal input terminal 2a and LO signal input terminal 1a to the antiparallel diode pair 6a via the wave splitter circuit 4a.

When the pulse signal that has three voltage values and the mixing duty of 50% as illustrated in FIG. 2(c) is input to the LO signal input terminal 1a to operate the even harmonic mixer as the down converter, the mixer diodes 5a and 5b of the antiparallel diode pair 6a are brought into conduction alternately at every half period, thereby enabling the current to flow. The RF signal and the LO signal are mixed by repeating the operation, and a mixed wave with the following frequency is generated across the antiparallel diode pair 6a.
fₒᵤₜ=f_{RF}−2mf_{LO}
where m is an integer.

The output with the intermediate frequency f_{IF}=f_{RF}−2f_{Lo} can be obtained by wave splitting the mixed wave having a plurality of frequencies by the wave splitter circuit 4a. The wave splitter circuit 4a has the bandpass filter 4c at the RF signal input side, and the low-pass filter 4e at the IF signal output side.

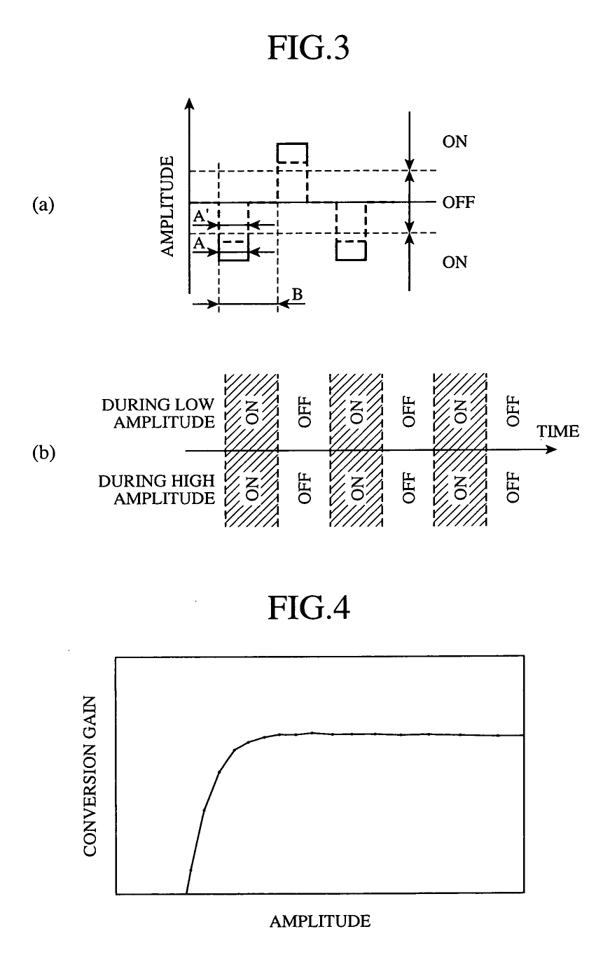

FIG. 3(a) is a diagram illustrating a case in which the amplitude varies of the local oscillation signal of the even harmonic mixer in accordance with the present invention; and FIG. 3(b) is a diagram illustrating that the mixing duty is kept constant regardless of the variations in the amplitude of the local oscillation signal of the even harmonic mixer in accordance with the present invention. As illustrated in FIGS. 3(a) and 3(b), using the pseudo-sine wave having the three-step voltage values as the local oscillation signal makes it possible to maintain the mixing duty regardless of the variations in the amplitude of the local oscillation signal. Consequently, the present embodiment 1 of the even harmonic mixer can perform stable operation. FIG. 4 illustrates the dependence of the conversion gain of the embodiment 1 of the even harmonic mixer in accordance with the present invention on the amplitude of the local oscillation signal. As illustrated in FIG. 4, the mixing duty is kept constant when the amplitude of the LO signal is greater than a specified value even if the amplitude varies. As a result, the conversion gain becomes substantially constant, thereby stabilizing the operation.

As described above, the embodiment 1 of the mixer circuit in accordance with the present invention generates a pseudo-sine wave, which has three voltage values and the duty of 50%, by the adder from the two pulse signals which are supplied from outside and have phases shifted by ¼ period, and employs it as the LO signal. Thus, the present embodiment 1 can keep the ratio of the on and off periods of the mixer circuit constant regardless of the amplitude of the pulses, thereby being able to implement the stable operation mixer circuit.

In addition, although the present embodiment 1 is described by way of example that employs the pulse signal generator 14 as the local oscillation signal generator, and that is easily applied to a portable phone and the like, this is not essential. For example, as for an analog oscillation circuit that generates a sine wave, such a configuration is possible that provides a well-known sine wave-pulse wave converting circuit (such as a Schmitt trigger circuit) before the adder circuit LO signal input terminals 11a and 11b, and supplies the pulse signals to the adder circuit 12a. Alternatively, a configuration is also possible that synthesizes the pulse waveform obtained from the sine wave into the pseudo-sine wave as illustrated in FIG. 2(c). In this case, the pulse signal generator 14 and delay circuit 15 as shown in FIG. 1 are replaced by the sine wave generator plus the pulse wave generator.

Furthermore, although the present embodiment 1 is described by way of example that generates the LO signal using the two pulse signals with their phases shifted by ¼ period, the shift of the phase is not limited to that amount. In addition, although the present embodiment 1 is described by way of example using the down converter, it is also applicable to an up converter which is supplied with the IF signal instead of the RF signal, to produce the RF signal with a frequency f_{IF}+2f_{LO} from the output terminal.

Finally, although the embodiment explains the even harmonic mixer using the antiparallel diode pair 6a as an example of the even harmonic mixer 20 having the single LO signal input terminal, this is not essential. For example, as the even harmonic mixer 20 including the single LO signal input terminal, it is also possible to employ an active operation mixer using junction bipolar transistors or field effect transistors. The present embodiment 1 is also applicable to a mixer other than the even harmonic mixer.

### Embodiment 2

Next, the embodiment 2 in accordance with the present invention will be described. In the foregoing embodiment 1, the mixer circuit operating on the single LO signal is described. In contrast with this, the present embodiment 2 will be described by way of example that supplies an even harmonic mixer, which is operated by two differential signals with opposite phases, with two pseudo-sine waves that have three-step voltage values and a mixing duty of 50% as the LO signals.

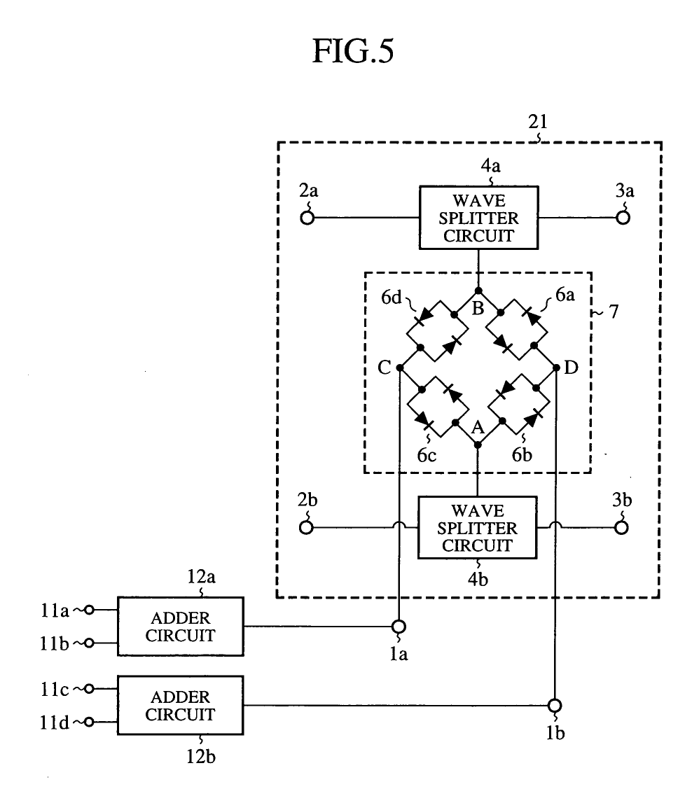

FIG. 5 is a diagram showing a circuit configuration of an embodiment 2 of the even harmonic mixer in accordance with the present invention. In FIG. 5, the reference numeral 1b designates an LO signal input terminal, 2b designates an RF signal input terminal, 3b designates an IF signal output terminal, 4b designates a wave splitter circuit, 6a, 6b, 6c and 6d each designate an antiparallel diode pair, 7 designates an antiparallel diode pair ring, 11c and 11d each designate an adder circuit LO signal input terminal, 12b designates an adder circuit, and 21 designates an even harmonic mixer including a plurality of LO signal input terminals 1a and 1b.

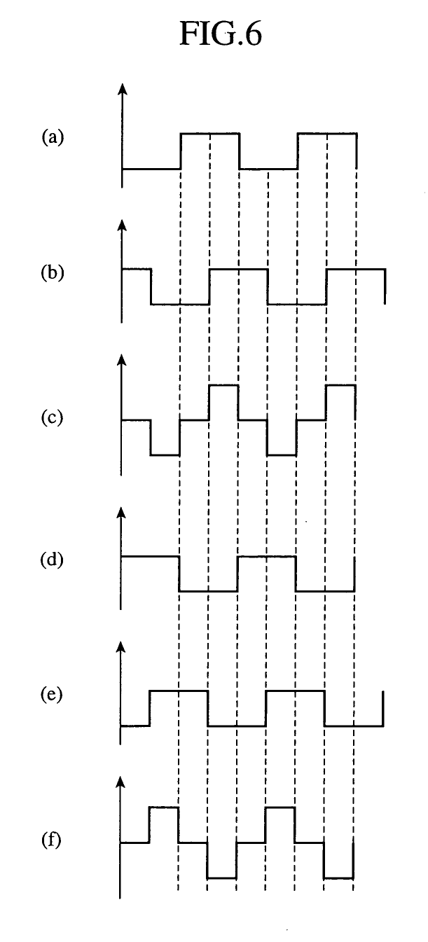

The present embodiment 2 of the even harmonic mixer as shown in FIG. 5 has four antiparallel diode pairs connected in a ring. The adder circuit LO signal input terminals 11a and 11b are supplied with the LO signal pulse waves whose phases are shifted by ¼ period as illustrated in FIGS. 6(a) and 6(b) as in the foregoing embodiment 1. On the other hand, the adder circuit LO signal input terminals 11c and 11d are supplied with the LO signal pulse waves having the opposite phases to the pulse signals fed to the adder circuit LO signal input terminals 11a and 11b as illustrated in FIGS. 6(d) and 6(e). In addition, the RF signal input terminals 2a and 2b are supplied with the RF signals having the opposite phases as illustrated in FIGS. 6(c) and 6(f).

In FIG. 5, the symbols A, B, C and D designate connecting points of the antiparallel diode pairs 6a, 6b, 6c and 6d. The RF signal is supplied to the points A and B, and the LO signal is supplied to the points C and D. In other words, the RF signal and LO signal are connected to the points that become the middle points of the bridge with each other. Accordingly, the point A passes the current corresponds to the difference between the two LO signals fed to the points C and D, and the wave splitter circuit 4b mixes the two LO signal with the RF signal, thereby generating the IF signal with the frequency f_{IF}=f_{RF}−2f_{LO}.

The IF signal generated by the wave splitter circuits 4a and 4b is split from the RF signal by a low-pass filter (not shown) in the wave splitter circuit, and is output from the output terminal 3a or 3b. Since the IF signals output from the output terminals 3a and 3b are a differential output, they have opposite phases.

In this way, the present embodiment 2 of the mixer circuit can perform stable operation against the variations in the LO signal amplitude as in the embodiment 1. In addition, since it has the differential input and output, it can facilitate the connection to an external circuit, when the external circuit has the differential input or differential output. Furthermore, the present embodiment 2 offers an advantage of being able to eliminate the noise of the same phase mode due to electromagnetic interference.

### Embodiment 3

Next, the embodiment 3 in accordance with the present invention will be described. The foregoing embodiment 2 handles the even harmonic mixer circuit that uses the two LO signals with the opposite phases as the differential signal, and carries out the passive operation. The present embodiment 3 is the same as the foregoing embodiment 2 in that it uses the two LO signals with the opposite phases as the differential signal, but differs from the embodiment 2 in that it employs differential circuits each of which composed of a junction bipolar transistor pair, and performs active operation. The even harmonic mixer will be described assuming that it employs the pseudo-sine wave having the three-step voltage values and the mixing duty of 50% as the LO signals.

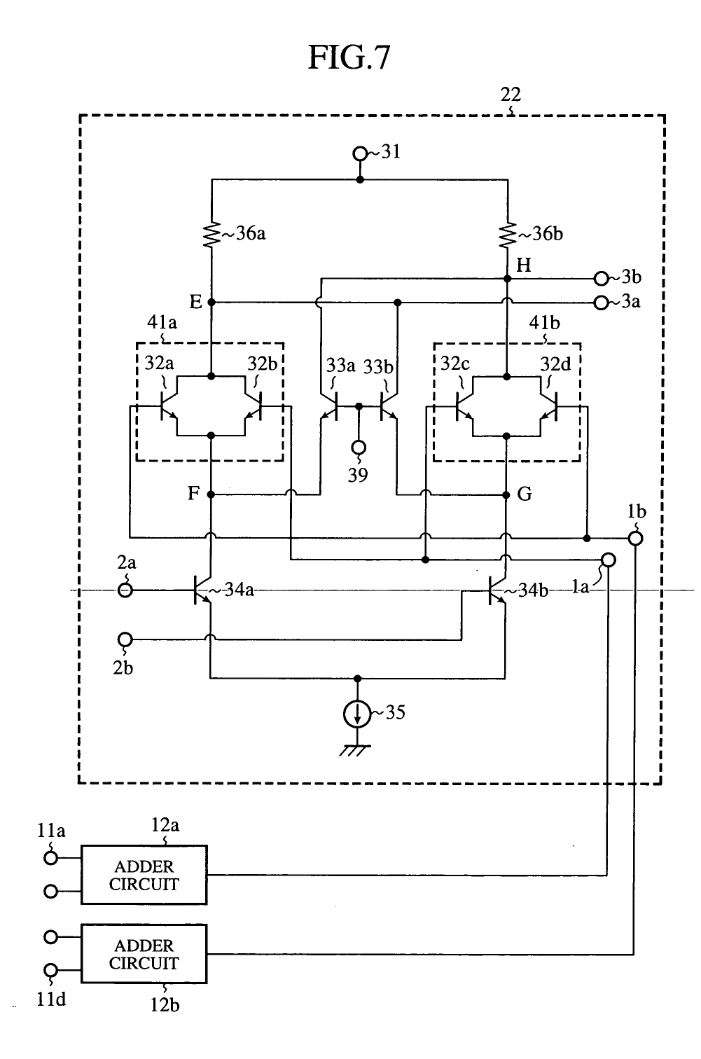

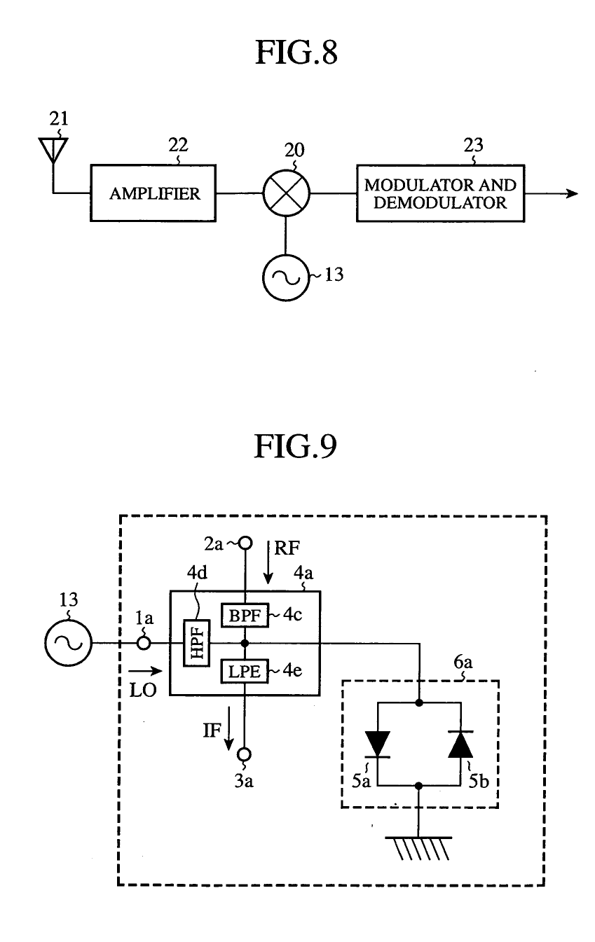

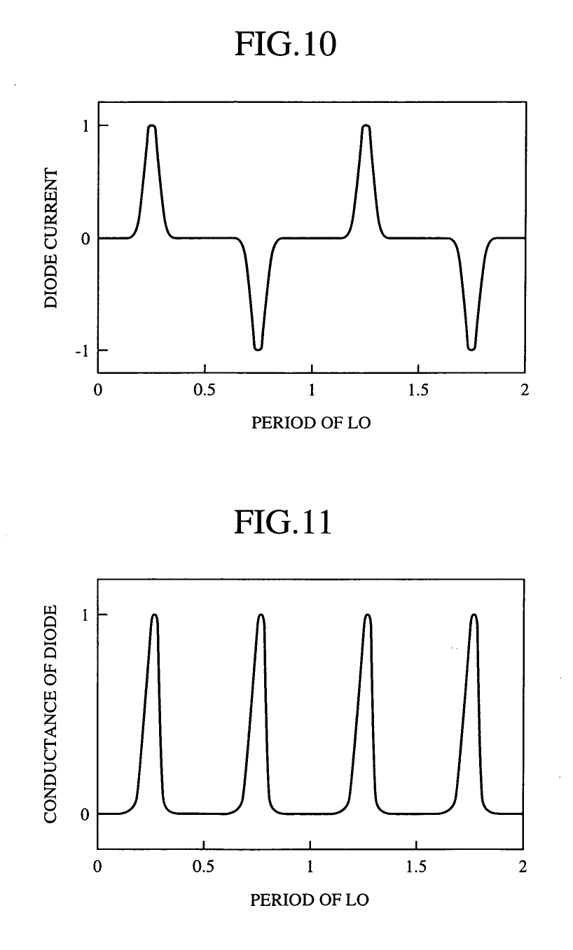

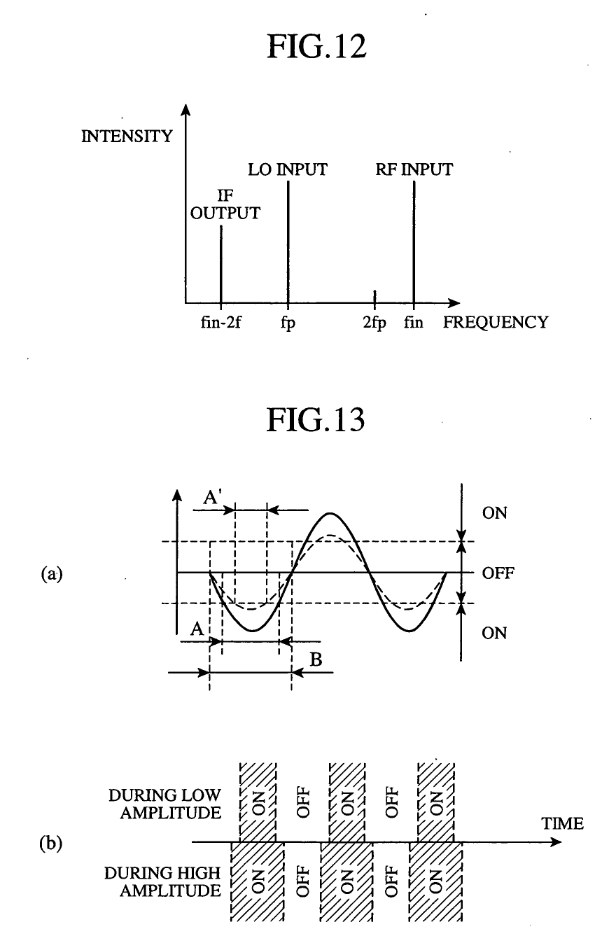

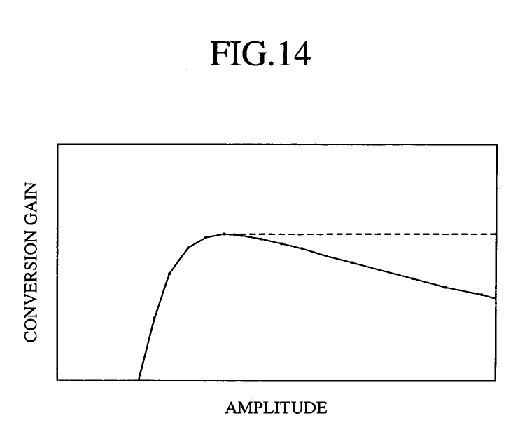

FIG. 7 is a diagram showing a circuit configuration of the present embodiment 3 of the even harmonic mixer. In FIG. 7, the reference numeral 22 designates an even harmonic mixer of the present embodiment 3 that carries out the active operation, 31 designates a power supply (Vcc) terminal, 32a and 32b each designate an NPN transistor for LO signal input, 33a and 33b each designate a reference NPN transistor, 34a and 34b each designate an NPN transistor for RF signal input, 35 designates a constant current source, 36a and 36b each designate a load resistor, 39 designates a reference bias terminal, and 41a and 41b each designate an NPN transistor pair.

The present embodiment 3 of the even harmonic mixer applies the DC voltage Vcc to the power supply terminal 31 so that the voltage is supplied to the LO signal input NPN transistors 32a, 32b, 32c and 32d, and to the reference NPN transistors 33a and 33b via the load resistors 36a and 36b, and that the constant current source 35 supplies them with the constant current to carry out the active operation.

Next, the operation will be described. Since the mixer circuit 22 is a symmetrical circuit, only the left half portion of FIG. 5 will be described which includes the LO signal input transistors 32a and 32b and RF signal input NPN transistor 34a. The adder circuit LO signal input terminals 11a, 11b, 11c and 11d are supplied with the same pulse signals as those of the foregoing embodiment 2. Accordingly, the LO signal input terminals 1a and 1b are supplied with the pseudo-sine waves as illustrated in FIGS. 6(c) and 6(f), which have the three-step voltage values with the opposite phases, and have the mixing duty of 50%.

Thus, the LO signal input terminal 1a is supplied with the positive voltage, and the LO signal input terminal 1b is supplied with the negative voltage at the same time. Accordingly, the gate of the LO signal input NPN transistor 32b connected to the LO signal input terminal 1a is supplied with the voltage, and the current flows through the LO signal input NPN transistor 32b because of the voltage from the power supply terminal 31. In this case, in response to the RF signal input to the RE signal input terminal 2a, a current flows through the RF signal input NPN transistor 34a by means of the constant current source 35.

On the other hand, when the negative voltage is applied to the LO signal input terminal 1a, the positive voltage is applied to the LO signal input terminal 1b simultaneously. Thus, the gate of the LO signal input NPN transistor 32a connected to the LO signal input terminal 1b is supplied with the voltage so that the current flows through the LO signal input NPN transistor 32a. In this case also, in response to the RF signal input to the RF signal input terminal 2a, the current flows through the RF signal input NPN transistor 34a by means of the constant current source 35.

Carrying out the foregoing operations alternately, the LO signal is mixed with the RF signal, and the intermediate frequency signal is output from the output terminal 3a. The right side portion of the mixer circuit 22, which includes the LO signal input NPN transistors 32c and 32d, and the RF signal input NPN transistor 34b, performs operation similar to the operation described above in response to the pulse inputs to the LO signal input terminals 1a and 1b. The output terminal 3a acquires the output from the points E and G of FIG. 7, and the output terminal 3b acquires the output from the points F and H. Thus, the same phase intermediate frequency signals are output, providing a higher conversion gain.

In this way, the present embodiment 3 carries out the mixing not by mixing the RF signal and LO signal directly, but by mixing them via the bases of the transistors, which obviates the need for the wave splitter circuit, and hence can downsize the circuit.

In addition, it is not necessary for the pulse signals supplied to the adder circuit LO signal input terminals 11a and 11b to have the ¼ period difference in their phases as in the foregoing embodiments 1 and 2, although the phase difference gives the high conversion gain.

Furthermore, the present embodiment 3 is applicable not only to the down converter, but also to the up converter as the foregoing embodiments 1 and 2. Besides, although the present embodiment 3 describes the even harmonic mixer using the NPN transistors, it can employ PNP transistors or field effect transistors.

As described above, the present embodiment 3 applies as the LO signals the pseudo-sine waves, which have the three-step voltage values and the mixing duty of 50%, to the even harmonic mixer with the differential input using the junction bipolar transistors. This makes it possible to carry out stable operation regardless of the variations in the LO signal amplitude as in the embodiment 2. In addition, the present embodiment 3 facilitates the connection to an external circuit when the external circuit has a differential input or differential output. Furthermore, the present embodiment 3 can eliminate the noise in the same phase mode due to electromagnetic interference, and implement the high conversion gain because the individual transistors are supplied with the power from the power supply terminal, and hence have a gain. Thus the present embodiment 3 offers an advantage of being able to downsize the circuit scale because it can eliminate the need for the wave splitter circuit.

### INDUSTRIAL APPLICABILITY

As described above, the mixer circuit in accordance with the present invention employs the pseudo-sine wave as the local oscillation signal, which makes it possible to provide the mixer circuit capable of carrying out stable operation regardless of the variations in the amplitude of the local oscillation signal.

1. A mixer circuit comprising:
a signal synthesizing circuit for synthesizing and outputting a pseudo-sine wave from one of a pulse signal and a sine wave which are input from outside and have a constant period; and
a mixing section for mixing the pseudo-sine wave with a target signal input from outside, and for frequency converting and outputting a mixed signal.

2. The mixer circuit according to claim 1, wherein said signal synthesizing circuit consists of an adder circuit that adds a first pulse signal with a constant period and a second pulse signal with a phase shifted by a specified period from the first pulse signal, and outputs the pseudo-sine wave.

3. The mixer circuit according to claim 2, wherein the specified period is ¼ period.

4. The mixer circuit according to claim 1, wherein
said signal synthesizing circuit generates a first and second pseudo-sine waves which have opposite phases to each other; and
said mixing section mixes the first pseudo-sine wave with a first target signal, mixes the second pseudo-sine wave with a second target signal, and carries out frequency conversion of mixed signals and outputs them.

5. The mixer circuit according to claim 4, wherein said signal synthesizing circuit comprises:
a first adder circuit for outputting the first pseudo-sine wave by adding a first pulse signal with a constant period and a second pulse signal with a phase shifted by a specified period from the first pulse signal; and
a second adder circuit for outputting the second pseudo-sine wave by adding a third pulse signal with a phase opposite to the phase of the first pulse signal and a fourth pulse signal with a phase opposite to the phase of the second pulse signal.

6. The mixer circuit according to claim 4, wherein the specified period is ¼ period.

7. The mixer circuit according to claim 1, wherein said mixing section includes an antiparallel diode pair consisting of two antiparallel diodes.

8. The mixer circuit according to claim 4, wherein
said mixing section comprises an antiparallel diode pair ring having four antiparallel diode pairs connected in a ring, each of said antiparallel diode pairs consisting of two antiparallel diodes;
said mixing section comprises input terminals at four connecting points between said antiparallel diode pairs;
second and third input terminals, which are adjacent to a first input terminal to which a first local oscillation signal is input, have one of the second and third input terminals supplied with a first target signal and the other of the second and third input terminals supplied with a second target signal;
a fourth input terminal is supplied with a second local oscillation signal; and
said second and third input terminals serve as an output terminal of a frequency converted signal.

9. The mixer circuit according to claim 4, wherein said mixing section comprises:
first and second transistor pairs, each of which includes two junction transistors connected in parallel with their emitters connected to each other and their collectors connected to each other, and has their bases supplied with the first and second local oscillation signal;
a power supply terminal connected to the collector sides of said first and second transistor pairs;
a first target signal input transistor having its collector connected to an emitter side of said first transistor pair, and its base connected to a first target signal input terminal;
a second target signal input transistor having its collector connected to an emitter side of said second transistor pair, and its base connected to a second target signal input terminal;
a first output terminal connected to a collector side of said first transistor pair, and to an emitter side of said second transistor pair; and
a second output terminal connected to an emitter side of said first transistor pair, and to a collector side of said second transistor pair.
